(19) United States
(12) Patent Application Publication
(10) Pub. No.: US 2009/0238543 A1
(43) Pub. Date: Sep. 24, 2009

(54) Local Recording of Previously Aired Programming

(75) Inventor: Terry Qing Guo, Mountain View, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/052,707

(22) Filed: Mar. 20, 2008

(51) Int. Cl. H04N 7/26

(52) U.S. Cl. 386/124

(57) ABSTRACT

In accordance with one or more aspects, a request to locally record at least a portion of a program aired over an IP-based network is received. In response to the request a network buffer at which previously aired programs have been temporarily stored is accessed over the IP-based network. The requested portion is downloaded over the IP-based network from the network buffer to a local storage device. In accordance with additional aspects, information identifying a popularity of each of multiple programs being aired can be obtained. Based on the information, one or more highly popular programs of the multiple programs are identified. Additionally, a request is sent to each of multiple client devices for the client device to download the one or more highly popular programs after the one or more highly popular programs have aired.

### BACKGROUND

Television viewing and recording technology has been continually advancing, with hundreds of channels, digital video recorders (DVRs), and video-on-demand programs finding their way into many homes. Despite such advances, problems still remain. One such problem is that although users with DVRs are able to record programs broadcast over cable and satellite channels that are currently airing, as well as programs to be broadcast in the future, there is frequently little if any ability for users to record programs that have already been broadcast. This situation can be problematic for users as it requires them to be proactive about identifying current and upcoming programs that they want to watch, and leaving little recourse when they discover a program they wanted to watch has already aired and they did not request that it be recorded prior to airing.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects of the local recording of previously aired programming, a request to record a program locally is received after the program has aired over an IP-based network. In response to the request a network buffer at which previously aired programs have been temporarily stored is accessed over the IP-based network. The requested program is downloaded over the IP-based network from the network buffer to a local storage device.

In accordance with one or more aspects of the local recording of previously aired programming, a program being aired over an IP-based network is received. After at least a portion of the program that has already been aired is unavailable from a local buffer, a record request is received during airing of the program. A portion of the program is recorded on a local storage device as the program is aired over the IP-based network. Additionally, a remaining portion of the program is downloaded over the IP-based network from a network buffer at which previously aired programming has been temporarily stored to the local storage device.

In accordance with one or more aspects of the local recording of previously aired programming, information identifying a popularity of each of multiple programs being aired is obtained. Based on the information, one or more highly popular programs of the multiple programs are identified. Additionally, a request is sent to each of multiple client devices for the client device to download the one or more highly popular programs after the one or more highly popular programs have aired.

### BRIEF DESCRIPTION OF THE DRAWINGS

The same numbers are used throughout the drawings to reference like features.

FIG. 1 illustrates an example system implementing the local recording of previously aired programming in accordance with one or more embodiments.

FIG. 2 is a flowchart illustrating an example process for local recording of previously aired programming in accordance with one or more embodiments.

FIG. 3 is a flowchart illustrating another example process for local recording of previously aired programming in accordance with one or more embodiments.

FIG. 4 is a flowchart illustrating another example process for local recording of previously aired programming in accordance with one or more embodiments.

FIG. 5 is a flowchart illustrating an example process for downloading requested programs in accordance with one or more embodiments.

FIG. 6 illustrates various components of an example client device in accordance with one or more embodiments.

FIG. 7 illustrates an example entertainment and information system in which one or more embodiments of the local recording of previously aired programming can be implemented.

### DETAILED DESCRIPTION

Local recording of previously aired programming is discussed herein. A content distributor maintains a network buffer that temporarily stores all programs that are aired by the content distributor. Client devices can then download these programs from the network buffer in response to user requests for the programs after the programs have aired. The content distributor can also identify highly popular programs and send a request for the client devices to download these highly popular programs from the network buffer after the programs have aired. These highly popular programs are then available from a local storage device when requested by the user, rather than being downloaded from the network buffer when requested by the user.

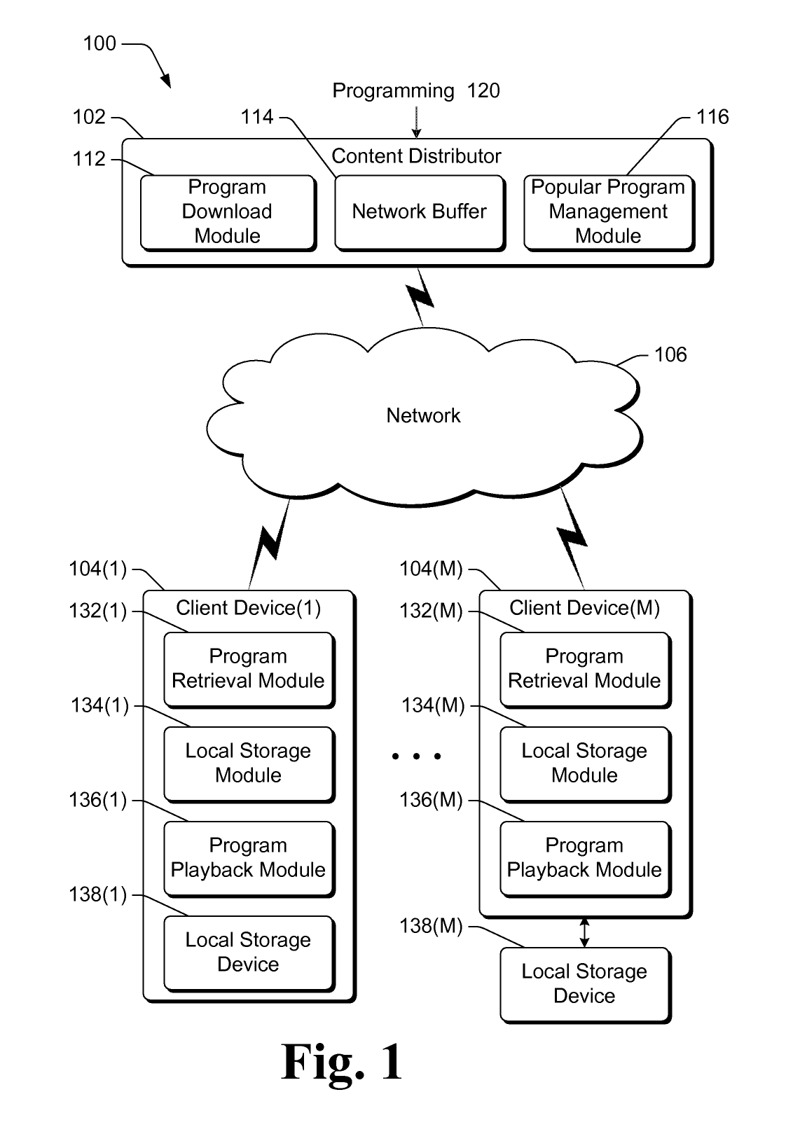

FIG. 1 illustrates an example system 100 implementing the local recording of previously aired programming in accordance with one or more embodiments. System 100 includes a content distributor 102 that can communicate with one or more (M) client devices 104(1-M) via a network 106. Network 106 can be any of a variety of networks, including the Internet, a local area network (LAN), a public telephone network, an intranet, other public and/or proprietary networks, combinations thereof, and so forth. In one or more embodiments network 106 is implemented to include an Internet Protocol (IP)-based network that facilitates programming content distribution and data communication between the content distributor 102 and any number of client devices 104. An IP-based network is a network that supports communication among devices using IP, such as IP version 4 (IPv4, such as discussed in IETF RFC 791), as well as other version such as IP version 6 (IPv6).

Content distributor 102 includes a program download module 112, a network buffer 114, and a popular program management module 116. Generally, content distributor 102 receives programming 120 from one or more sources as the programming is aired by the source(s), and stores the aired programming in network buffer 114. This programming is then made accessible to client devices 104 after (and during) airing of the programming so that the programming can be downloaded and stored in a local storage device of client devices 104. Content distributor 102 can be implemented as one or more devices. Additionally, although a single content distributor 102 is illustrated in FIG. 1, alternatively multiple content distributors can communicate with client devices 104 via network 106.

Content distributor 102 receives programming 120 that includes programs from one or more sources, such as a satellite operator, a network television operator, a cable operator, and so forth. This programming can be received from the sources via any of a variety of transmission media, such as satellite transmission, radio frequency transmission, cable transmission, and so forth. Programming 120 can include any of a variety of different programs, such as television sitcoms, news broadcasts, documentaries, cartoon shows, movies, and so forth. These programs can optionally include advertisements as well. Any program that can be aired by a source can be included as a program of programming 120. The airing of a program refers to the transmitting of the program by the source via any transmission media. In one or more embodiments, content distributor 102 distributes programming 120 to client devices 104. Alternatively, programming 120 can be communicated to client devices 104 from other sources rather than via content distributor 102.

The programs received as programming 120 are stored temporarily in network buffer 114. In one or more embodiments, all programs received as programming 120 received by content distributor 102 are stored in network buffer 114 temporarily. Alternatively, content distributor 102 can optionally impose one or more filters to restrict which programs are stored in network buffer 114. Network buffer 114 stores programs temporarily, and the duration of this temporary storage can vary. For example, the duration can be 48 hours, 72 hours, 1 week, and so forth. It is to be appreciated that the exact duration of this temporary storage can vary by implementation and based on the desires of an operator of content distributor 102.

Program download module 112 receives requests from client devices 104 for programs, or portions of programs, that have previously been aired. Program download module 112 accesses network buffer 114 to obtain the desired program, or portion of a program, and returns the requested program (or portion thereof) to the requesting client device 104 via network 106.

Popular program management module 116 obtains information identifying the popularity of various programs of programming 120. This information can be generated by module 116 or alternatively received from another device or component. Module 116 uses this information to identify one or more highly popular programs in programming 120. Module 116 then communicates a request to one or more client devices 104 to download the one or more highly popular programs. Client devices 104 in turn request the one or more highly popular programs from program download module 112, which transfers the requested programs from network buffer 114 to the requesting client devices 104.

Each client device 104 can be any of a variety of types of devices, and different client devices 104 can be different types of devices. For example, a client device 104 can be a desktop computer, a mobile station, an entertainment appliance, a television, a portable computer, a television set-top box, a wireless phone, a gaming system, an automotive computer, and so forth. Thus, client devices 104 may range from a full resource device with substantial memory and processor resources (e.g., personal computers, game consoles) to a low-resource device with limited memory and/or processing resources (e.g., traditional set-top boxes, hand-held game consoles).

Each client device 104 includes a program retrieval module 132, a local storage module 134, and a program playback module 136. Program retrieval module receives requests to download programs from content distributor 102. These requests can be received from a user of client device 104, from popular program management module 116, or from other components or devices. In response to a request to download a program (or portion of a program), program retrieval module 132 sends a request for the program (or portion thereof) to content distributor 102. Program retrieval module 132 then receives the requested program (or portion thereof) from download module 112.

Local storage module 134 manages the storage of programs on a local storage device of client device 104. In one or more embodiments this local storage device is included as part of client device 104 (e.g., an internal disk drive of client device 104). An example of such a local storage device is shown as storage device 138(1). Alternatively, this local storage device can be coupled to client device 104, such as via a bus (e.g., an IEEE 1394 bus, a universal serial bus (USB), etc.), via a local network (e.g., a LAN), and so forth. An example of such a local storage device is shown as storage device 138(M). Programs that are downloaded from content distributor 102 by program retrieval module 132 are stored in the local storage device 138 by local storage module 134.

Program playback module 136 manages the playback of programs by client device 104. Client device 104 can include display and/or audio playback components via which programs are played back, or alternatively client device 104 can output a signal to one or more other components or devices which in turn can display and/or audibly playback the programs. The video content of programs can be played back on any type of television, monitor, LCD, projector, or similar television-based display system that renders video and/or image data. The audio content of programs can be played back on any type of television, stereo, or similar television-based audible playback system that renders audio data. The programs played back by program playback module 136 can be programs retrieved from a local storage device 138 by local storage module 134. Additionally, the programs played back by module 136 can also be retrieved from other components or devices, such as from content distributor 102, directly from a programming source, and so forth. Playback module 136 can playback programs that have been received in their entirety, as well as portions of programs (e.g., one part of a program can be played back while one or more other parts of the program are being received from content distributor 102).

Users can input requests to client devices 104 for programs to be recorded in any of a variety of manners. In one or more embodiments, an electronic programming guide (EPG) is displayed to the user. The EPG includes a listing of various programs that are available, and optionally other information such as a channel on which the programs are available, a time at which the programs are (or were) aired, summary information describing the programs, and so forth. The user can navigate through the EPG in any of a variety of conventional manners (e.g., using directional keys on a remote control device) to select a particular program that he or she desires to have recorded. Alternatively, such requests can be input in other manners, such as selection of a program from a drop-down menu, inputting text identifying the program, selecting a record button on a remote control (e.g., during playback of a program), and so forth. Additionally, requests can optionally be forwarded to client device 104 from another device. For example, a user of a computing device while at work can send a request to client device 104 to have a particular program recorded.

Additionally, in one or more embodiments each client device 104 presents a user interface (UI) to the user that identifies various information regarding the downloading previously aired programs to client device 104. This information can include, for example, an indication of which previously aired programs have been downloaded, an indication of which previously aired programs are currently being downloaded (and optionally an indication of when the download is estimated to be completed), an indication of which previously aired programs are still to be downloaded, an indication of which previously aired programs are available for download, and so forth. An indication of an initiator (e.g., the user of the client device, or a content distributor in the case of highly popular programs as discussed in more detail below) of the download requests can also be presented as part of the UI.

Downloading previously aired programs from network buffer 114 to local storage device 138 of a client device 104 has numerous benefits. As discussed above, the duration of the temporary storage in network buffer 114 can be limited (i.e., programs may not be stored forever) and is typically not under the user's control. By storing the program on local storage device 138 of client device 104, the program can be kept available to the user until deleted by the user. Additionally, downloading of the previously aired program to local storage device 138 of client device 104 can be performed during times of lower network and/or bandwidth utilization, such as overnight. The bandwidth refers to a transfer rate for the program data, which can vary at different times based on the network between content distributor 102 and client device 104, the network load (e.g., how much other data is being transferred over the network at a particular time), a load of content distributor 102 (e.g., how much data is being sent by content distributor 102 at a particular time), a load of client device 104 (e.g., how much data is being sent and/or received by client device 104 at a particular time), and so forth. The downloading of the previously aired program can also be performed at a rate slower than would be used if the program were being watched at the same time. For example, a 60-minute show could be downloaded over a period of 2-3 hours using a lower bandwidth.

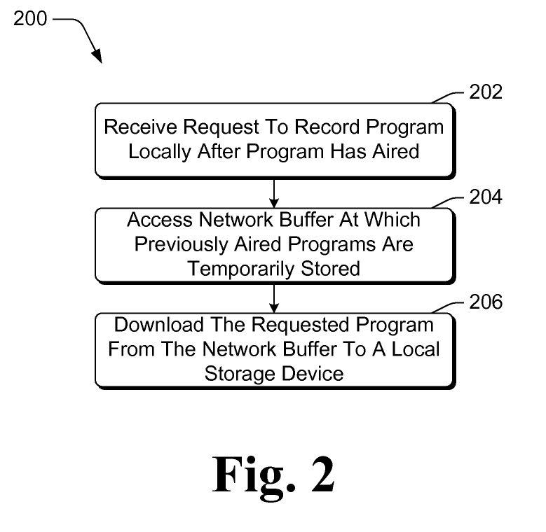

FIG. 2 is a flowchart illustrating an example process 200 for local recording of previously aired programming in accordance with one or more embodiments. Process 200 is carried out by a client device, such as a device 104 of FIG. 1, and can be implemented in software, firmware, hardware, or combinations thereof Process 200 is an example process for local recording of previously aired programming in situations where a request to record a program is received after the program has aired. Additional discussions of local recording of previously aired programming are included herein with reference to different figures.

Initially, a request to record a program locally after the program has aired is received (act 202). As the request to record the program is received after the program has already aired, the program cannot be recorded as the program is aired. Accordingly, a network buffer at which previously aired programs are temporarily stored is accessed (act 204). In one or more embodiments, the network buffer is accessed by sending a request to a program download module 112 of a content distributor 102 of FIG. 1. The requested program is then downloaded from the network buffer to a local storage device (act 206). As discussed above, this local storage device can be included as part of the client device downloading the program, or alternatively can be coupled to the client device.

This downloading in act 206 can occur immediately, or alternatively can be delayed. The user can optionally request that the download occur immediately, or alternatively indicate that the download need not occur immediately. For example, the user can enter requests to download multiple programs and have those multiple programs downloaded overnight when network load or usage between the network buffer and the client device is lighter, when data transfer rates are less expensive, and so forth.

Once the program is downloaded to the local storage device, the user of the client device has a local copy of the program that the user can watch at his or her leisure. The user need not be concerned with how long programming is maintained in network buffer 114 of FIG. 1 as the program is now stored on his or her local storage device.

Additionally, it should be noted that situations can arise where the user requests to watch a previously aired program. Such a request can be made at the same time (or close to the same time) as a request to record the program is made, so that the downloading in act 206 is being performed concurrently with the user watching the program. Alternatively, any request by the user to watch a previously aired program can be treated by the client device as including a request to record the program in act 202.

In situations where the user is watching the program and the program is also being downloaded, the program can be recorded to the local storage device as it is received for playback to the user. Thus, an additional copy of the program need not be downloaded along with the copy of the program being played back. However, any portions of the program that are not played back by the user (e.g., because the user fast forwarded or skipped over a part of the program during playback) are still downloaded to the user. Thus, any holes or gaps in the program that may have otherwise occurred due to the manner in which the user played back the program can be filled by downloading, from the network buffer, those portions of the program that were not played back.

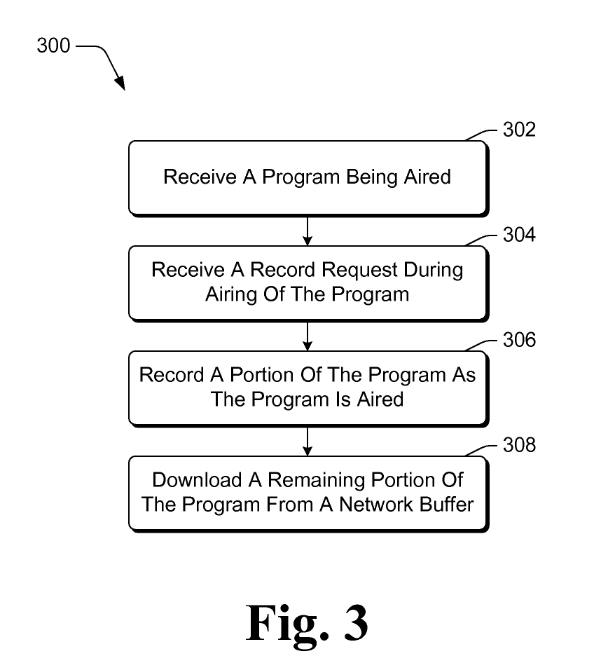

FIG. 3 is a flowchart illustrating an example process 300 for local recording of previously aired programming in accordance with one or more embodiments. Process 300 is carried out by a client device, such as a device 104 of FIG. 1, and can be implemented in software, firmware, hardware, or combinations thereof. Process 300 is an example process for local recording of previously aired programming in situations where a request to record a program is received while the program is being aired. Additional discussions of local recording of previously aired programming are included herein with reference to different figures.

Initially, a program being aired is received (act 302). In one or more embodiments the program being aired is received from a content distributor 102 of FIG. 1, although alternatively the program being aired is received from another programming source. A request to record the program is received during airing of the program (act 304). In one or more embodiments the client device includes a temporary local buffer in which at least a portion of the program currently being aired is stored temporarily. This local buffer typically has a limited duration (e.g., holding 15 or 30 minutes of programming), and oftentimes is cleared each time the user changes to a different program (e.g., changes channels). The request received in act 304 is received after at least a portion of the program that has already been aired is unavailable locally. In embodiments where such a temporary local buffer is used, the request is received after at least a portion of the program that has already been aired is unavailable from the local buffer.

In response to the request received in act 304, a portion of the program is recorded to the local storage device as the program is aired (act 306). This portion is the portion of the program that is aired after the request is received in act 304. This portion can also include any parts of the program that are still available in a local buffer of the client device.

Additionally, in response to the request received in act 304, a remaining portion of the program is downloaded from the network buffer to a local storage device (act 308). As discussed above, this local storage device can be included as part of the client device downloading the program, or alternatively can be coupled to the client device.

This downloading in act 308 can occur immediately (e.g., concurrently with the recording in act 308), or alternatively can be delayed. Whether this downloading in act 308 occurs immediately or is delayed can be determined based on various criteria, such as a user preference or request for immediate or delayed downloading, based on available bandwidth, and so forth.

Once the remaining portion of the program is downloaded to the local storage device and the program has finished airing, the user of the client device has a local copy of the program that the user can watch at his or her leisure. The user need not be concerned with how long programming is maintained in network buffer 114 of FIG. 1 as the program is now stored on his or her local storage device.

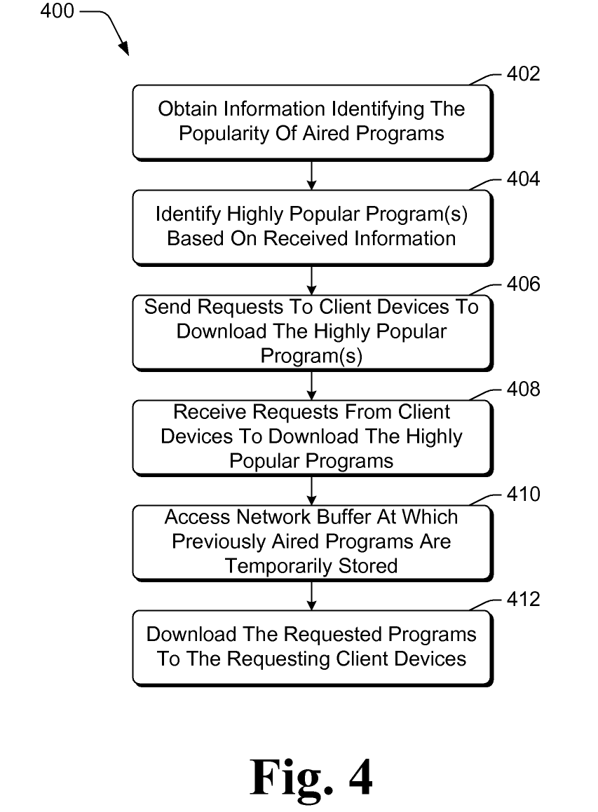

FIG. 4 is a flowchart illustrating an example process 400 for local recording of previously aired programming in accordance with one or more embodiments. Process 400 is carried out by a client device, such as a device 104 of FIG. 1, and can be implemented in software, firmware, hardware, or combinations thereof. Process 400 is an example process for local recording of previously aired programming. Additional discussions of local recording of previously aired programming are included herein with reference to different figures.

Initially, information identifying the popularity of aired programs is obtained (act 402). The popularity of aired programs refers to how popular particular programs were with users. This popularity can be represented in different manners, such as a ranking or rating identifying how many users watched the program as it was aired, a ranking or rating identifying how many users recorded the program as it was aired and/or after it was aired, a ranking or rating identifying how frequently the program is mentioned in blogs or articles on the Internet, and so forth. The information identifying the popularity can be generated by content distributor 102 of FIG. 1, or alternatively can be generated by another component or device and provided to content distributor 102.

In one or more embodiments, each client device 104 of FIG. 1 returns information to content distributor 102 (or alternatively another component or device) indicating which programs were watched and/or recorded by a user(s) of the client device. The information can be returned after the program is aired and/or during airing of the program. Alternatively, the popularity of a particular aired program can be identified in different manners, such as by receiving direct feedback from users regarding how well they liked the program, by accessing blogs or articles on the Internet to identify how much the program is discussed and/or whether it received positive reviews, by identifying how frequently a program is searched for using Internet search engines, and so forth.

Based on this information obtained in act 402, one or more highly popular programs are identified (act 404). These one or more highly popular programs can be identified automatically in a variety of different manners. For example, the programs aired over a particular time period (e.g., a 12-hour period, a 24-hour period, etc.) having the highest popularities can be automatically identified as the one or more highly popular programs. These could be a threshold number of programs (e.g., 3 programs, 5 programs, etc.) having the highest popularities during that particular time period. By way of another example, any program having at least a threshold popularity rating or ranking can be automatically identified as the one or more highly popular programs. Alternatively, a highly popular program(s) can be manually selected by an administrator or other user of content distributor 102 of FIG. 1. For example, an indication of a program that is expected by an administrator of content distributor 102 to be very popular can be identified as a highly popular program in act 404.

Requests are then sent to the client devices 104 of FIG. 1 to download the highly popular programs (act 406). These requests in act 406 identify the particular highly popular programs that are to be downloaded by the client devices. Additionally, these requests in act 406 can optionally identify an amount of bandwidth that is available to the client devices for downloading of the highly popular programs.

Requests for the highly popular programs are subsequently received from the client devices (act 408). In response to these requests, the network buffer at which the previously aired programs are temporarily stored is accessed (act 410). This accessing in act 410 is analogous to the accessing of act 204 discussed above with reference to FIG. 2. The requested programs are then downloaded to the requesting client devices where they are stored in a local storage device (act 412). This downloading in act 412 is analogous to the downloading of act 206 discussed above with reference to FIG. 2.

Additionally, different embodiments of process 400 can identify different sets of highly popular programs for different groups of client devices. Client devices can be grouped according to any of a variety of criteria such as the age of a user(s) of the device, a geographic location of the device, a marital status of a user(s) of the device, and so forth. A particular client device can optionally be included in multiple different groups. The information received in act 402 identifies the popularity of the aired programs for each of these different groups. For each of these different groups, a different set of highly popular programs can be identified in act 404. The requests sent to a particular client device in act 406 are then dependent on which group that particular client device is included in. For example, a first set of highly popular programs can be identified for client devices located in states on the east coast of the United States, and a second set of highly popular programs can be identified for client devices located in states on the west coast of the United States. Requests to download the first set of highly popular programs are sent to client devices located in states on the east coast of the United States, and requests to download the second set of highly popular programs are sent to client devices located in states on the west coast of the United States.

Thus, as can be seen from process 400, highly popular programs can be automatically downloaded to client devices. These highly popular programs can be identified in different manners, including automatically based on the actual viewing and/or recording of the programs by other users. By automatically downloading the highly popular programs to the user, the user has a local copy of the program that can be watched at his or her leisure. The user need not be concerned with how long programming is maintained in network buffer 114 of FIG. 1 as the program is now stored on his or her local storage device. The user also need not be concerned with requesting downloading of the program, as this has been done automatically for the user.

In one or more embodiments, when the same program is downloaded to multiple client devices, this downloading can be performed via multicast. When using multicast, a particular program is sent out on a multicast address by the source of the program (e.g., program download module 112 of FIG. 1). Each of the client devices that desire to receive that particular program can join the multicast address. If any data is not received by a client device during this multicast transmission, the client device can send a separate request to the source of the program to have the lost data sent via unicast (e.g., just to that particular client device rather than being re-broadcast via a multicast transmission).

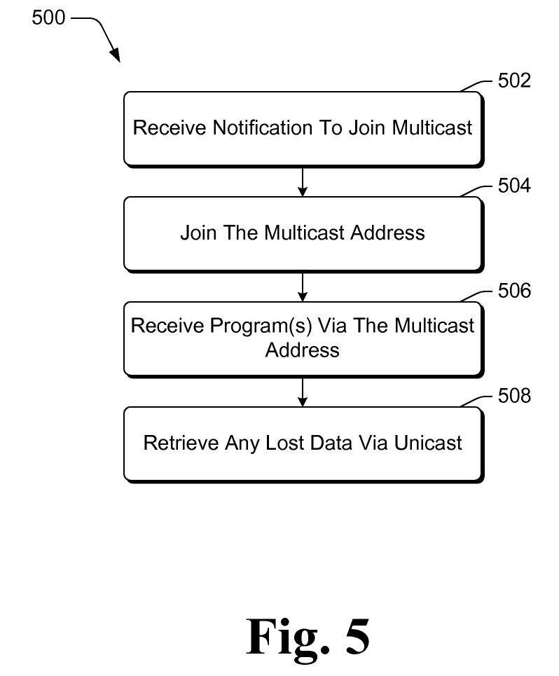

FIG. 5 is a flowchart illustrating an example process 500 for downloading requested programs in accordance with one or more embodiments. Process 500 is carried out by a client device, such as a device 104 of FIG. 1, and can be implemented in software, firmware, hardware, or combinations thereof. In one or more embodiments, process 500 is an example process for the downloading of requested programs in act 412 of FIG. 4.

Initially, a notification to join a multicast for the requested program is received (act 502). This notification is received from a source of the requested program, such as program download module 112 of FIG. 1. The client device joins the multicast address (act 504), allowing the client device to receive the program sent on that multicast address (act 506). Any data for the program that is not received during the multicast transmission (e.g., one or more packets that were lost during the multicast transmission) can be retrieved by the client device via a unicast transmission (act 508).

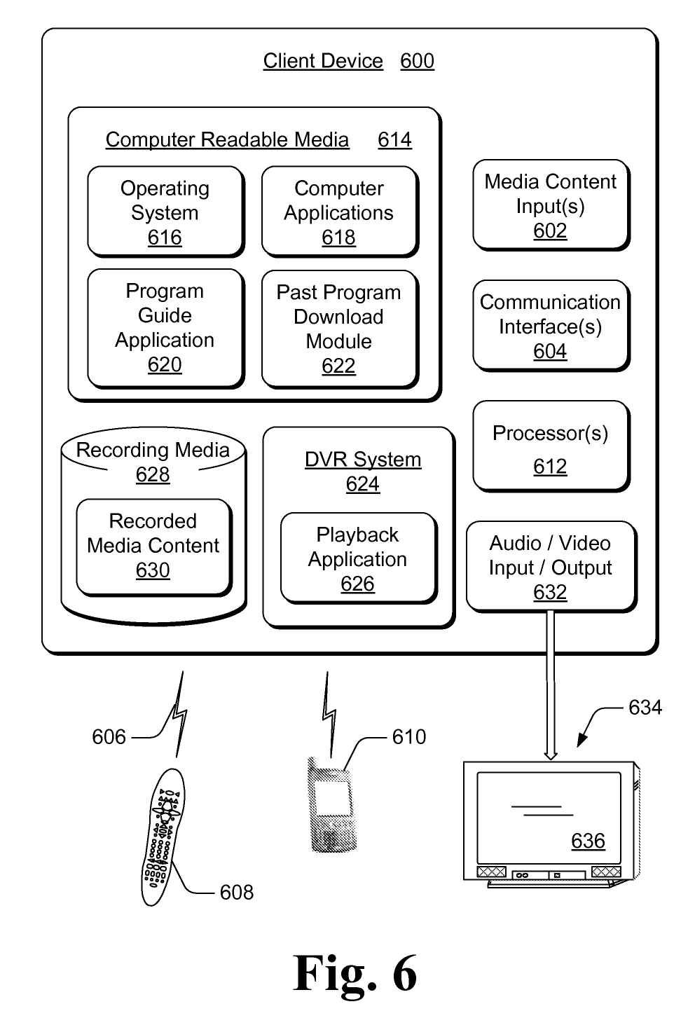

FIG. 6 illustrates various components of an example client device 600 that can be implemented as any form of a computing, electronic, or television client device to implement embodiments of the local recording of previously aired programming. For example, client device 600 can be implemented as any of the client devices 104(1-M) shown in FIG. 1. In various embodiments, client device 600 can be implemented as any one or combination of a television client device, a gaming system, or as any other computing-based device, such as a desktop computer, a portable computer, a television set-top box, a digital video recorder (DVR), an appliance device, a gaming console, and/or as any other type of computing-based client device.

Client device 600 includes one or more media content inputs 602 that may include Internet Protocol (IP) inputs over which streams of media content are received via an IP-based network. Client device 600 further includes communication interface(s) 604 that can be implemented as any one or more of a serial and/or parallel interface, a wireless interface, any type of network interface, a modem, and as any other type of communication interface. A wireless interface enables client device 600 to receive control input commands 606 and other information from an input device, such as from remote control device 608, a portable computing-based device (such as a cellular phone) 610, or from another infrared (IR), 802.11, Bluetooth, or similar RF input device.

A network interface provides a connection between client device 600 and a communication network by which other electronic and computing devices can communicate data with device 600. Similarly, a serial and/or parallel interface provides for data communication directly between client device 600 and the other electronic or computing devices. A modem facilitates client device 600 communication with other electronic and computing devices via a conventional telephone line, a DSL connection, cable, and/or other type of connection.

Client device 600 also includes one or more processors 612 (e.g., any of microprocessors, controllers, and the like) which process various computer-executable instructions to control the operation of device 600, to communicate with other electronic and computing devices, and to implement embodiments of the local recording of previously aired programming. Client device 600 can be implemented with computer-readable media 614, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), a DVD, a DVD+RW, and the like.

Computer-readable media 614 provides data storage mechanisms to store various information and/or data such as software applications and any other types of information and data related to operational aspects of client device 600. For example, an operating system 616 and/or other computer applications 618 can be maintained as software applications with the computer-readable media 614 and executed on processor(s) 612 to implement embodiments of the local recording of previously aired programming.

Client device 600 can also include a program guide application 620 that is implemented to process program guide data and generate program guides for display. A program guide enables a viewer to navigate through an onscreen display and locate various media content such as broadcast programs, recorded programs, video-on-demand programs and movies, interactive game selections, network-based applications, and other media content of interest to the viewer. Client device 600 can also include a past program download module 622 (shown as a software module in this example) to implement various embodiments of the local recording of previously aired programming as described herein.

Client device 600 can also include a DVR system 624 with playback application 626, and recording media 628 to maintain recorded media content 630 that client device 600 downloads (or otherwise receives) and/or records. Further, client device 600 may access or receive additional recorded media content that is maintained with a remote data store (not shown). Client device 600 may also receive media content from a video-on-demand server, or media content that is maintained at a broadcast center or content distributor that distributes the media content to subscriber sites and client devices. The playback application 626 is a video control application that can be implemented to control the playback of media content, the recorded media content 630, and/or other video-on-demand media content, music, and any other audio, video, and/or image media content which can be rendered and/or displayed for viewing.

Client device 600 also includes an audio and/or video output 632 that provides audio and/or video data to an audio rendering and/or display system 634. The audio rendering and/or display system 634 can include any devices that process, display, and/or otherwise render audio, video, and image data. Video signals and audio signals can be communicated from client device 600 to a display device 636 via an RF (radio frequency) link, S-video link, composite video link, component video link, DVI (digital video interface), analog audio connection, or other similar communication link. Alternatively, the audio rendering and/or display system 634 can be implemented as integrated components of the example client device 600. Client device 600 along with the audio rendering and/or display system 634 is an example of a viewing system that can be implemented in a household viewing area for viewing television programs and/or receiving other television media content.

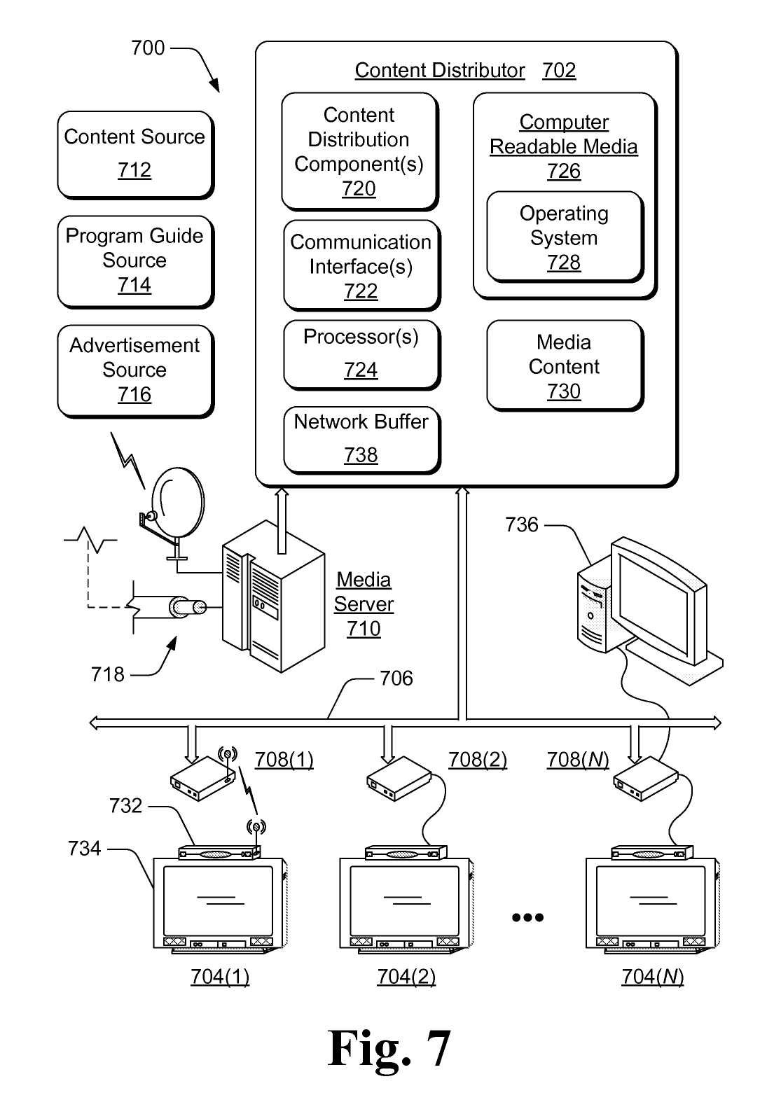

FIG. 7 illustrates an example entertainment and information system 700 in which embodiments of the local recording of previously aired programming can be implemented. System 700 facilitates the distribution of media content, program guide data, and advertising content to multiple viewers and to multiple viewing systems. System 700 includes a content distributor 702 and any number “N” of client systems 704(1-N) each configured for communication via a communication network 706. Each client system 704(1-N) is an example of the client devices 104(1-M) described with reference to FIG. 1. Each of the client systems 704(1-N) can receive data streams of media content, program content, program guide data, advertising content, closed captions data, and the like from content server(s) of the content distributor 702 via the communication network 706.

The communication network 706 can be implemented as any one or combination of a wide area network (e.g., the Internet), a local area network (LAN), an intranet, an IP-based network, a broadcast network, a wireless network, a Digital Subscriber Line (DSL) network infrastructure, a point-to-point coupling infrastructure, or as any other media content distribution network. Additionally, communication network 706 can be implemented using any type of network topology and any network communication protocol, and can be represented or otherwise implemented as a combination of two or more networks. A digital network can include various hardwired and/or wireless links 708(1-N), routers, gateways, and so on to facilitate communication between content distributor 702 and the client systems 704(1-N).

System 700 includes a media server 710 that receives media content from a content source 712, program guide data from a program guide source 714, and advertising content from an advertisement source 716. In one or more embodiments, the media server 710 represents an acquisition server that receives the audio and video media content from content source 712, an EPG server that receives the program guide data from program guide source 714, and/or an advertising management server that receives the advertising content from the advertisement source 716.

The content source 712, the program guide source 714, and the advertisement source 716 control distribution of the media content, the program guide data, and the advertising content to the media server 710 and/or to other servers. The media content, program guide data, and advertising content can be distributed via various transmission media 718, such as satellite transmission, radio frequency transmission, cable transmission, and/or via any number of other wired or wireless transmission media. In this example, media server 710 is shown as an independent component of system 700 that communicates the program content, program guide data, and advertising content to content distributor 702. In an alternate implementation, media server 710 can be implemented as a component of content distributor 702.

Content distributor 702 is representative of a headend service in a content distribution system, for example, that provides the media content, program guide data, and advertising content to multiple subscribers (e.g., the client systems 704(1-N)). The content distributor 702 can be implemented as a satellite operator, a network television operator, a cable operator, and the like to control distribution of media content, program and advertising content, such as movies, television programs, commercials, music, and other audio, video, and/or image content to the client systems 704(1-N).

Content distributor 702 includes various content distribution components 720 to facilitate media content processing and distribution, such as a subscriber manager, a device monitor, and one or more content servers. The subscriber manager manages subscriber data, and the device monitor monitors the client systems 704(1-N) (e.g., and the subscribers), and maintains monitored client state information.

Although the various managers, servers, and monitors of content distributor 702 (to include the media server 710 in one or more embodiments) are described as distributed, independent components of content distributor 702, any one or more of the managers, servers, and monitors can be implemented together as a multi-functional component of content distributor 702. Additionally, any one or more of the managers, servers, and monitors described with reference to system 700 can implement features and embodiments of the local recording of previously aired programming.

The content distributor 702 includes communication interface(s) 722 that can be implemented as any type of interface to communicate and receive data from client devices of the television system. The content distributor 702 also includes one or more processors 724 (e.g., any of microprocessors, controllers, and the like) which process various computer-executable instructions to control the operation of content distributor 702. The content distributor 702 also includes a network buffer 738 that operates analogous to network buffer 114 of FIG. 1, temporarily storing programs received from content source 712 (e.g., via media server 710). The content distributor 702 can be implemented with computer-readable media 726 which provides data storage to maintain software applications such as an operating system 728 and media content 730 for distribution to the client systems 704(1-N).

The client systems 704(1-N) can each be implemented to include a client device 732 and a display device 734 (e.g., a television, LCD, and the like). A client device 732 of a respective client system 704 can be implemented in any number of embodiments, such as a set-top box, a digital video recorder (DVR) and playback system, an appliance device, a gaming system, and as any other type of client device that may be implemented in an entertainment and information system. In an alternate embodiment, client system 704(N) is implemented with a computing device 736 as well as a client device. The computing device 736 is an example of a connected data store that can record and maintain media content for a client device. Additionally, any client device 732 of a respective client system 704 can implement features and embodiments of the local recording of previously aired programming as described herein.

Generally, any of the functions or techniques described herein can be implemented using software, firmware, hardware (e.g., fixed logic circuitry), manual processing, or a combination of these implementations. The terms “module,” “functionality,” and “logic” as used herein generally represent software, firmware, hardware, or combinations thereof. In the case of a software implementation, the module, functionality, or logic represents program code that performs specified tasks when executed on a processor (e.g., CPU or CPUs). The program code can be stored in one or more computer-readable memory devices, further description of which may be found with reference to FIGS. 6 and 7. The features of the local recording of previously aired programming techniques described herein are platform-independent, meaning that the techniques can be implemented on a variety of commercial computing platforms having a variety of processors.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. One or more computer-readable media having stored thereon multiple instructions that, when executed by one or more processors of a device, cause the one or more processors to:
receive, after a program has aired over an IP-based network, a request to record the program locally;
access, in response to the request, over the IP-based network a network buffer at which previously aired programs have been temporarily stored; and
download, over the IP-based network, the program from the network buffer to a local storage device.

2. One or more computer-readable media as recited in claim 1, the network buffer temporarily storing all previously aired programs received by a content distributor that includes the network buffer.

3. One or more computer-readable media as recited in claim 1, the local storage device comprising a storage device coupled to a same local area network as the device.

4. One or more computer-readable media as recited in claim 1, wherein to receive the request is to receive the request to record from a content distributor.

5. One or more computer-readable media as recited in claim 4, wherein the program is a program identified by the content distributor as being a highly popular program.

6. One or more computer-readable media as recited in claim 1, wherein to access the network buffer is to access a content distributor that includes the network buffer, the program having been previously aired over the IP-based network by the content distributor.

7. One or more computer-readable media as recited in claim 1, the instructions further causing the one or more processors to:
playback the program to a user of the device while downloading the program;
continue to download portions of the program to the local storage device that are fast forwarded over by the user.

8. A method implemented in a client device, the method comprising:
receiving a program being aired over an IP-based network;
receiving, after at least a portion of the program that has already been aired is unavailable from a local buffer, a record request during airing of the program;
recording a portion of the program on a local storage device as the program is aired over the IP-based network; and
downloading, over the IP-based network, a remaining portion of the program from a network buffer at which previously aired programming has been temporarily stored to the local storage device.

9. A method as recited in claim 8, the network buffer temporarily storing all previously aired programs received by a content distributor that includes the network buffer.

10. A method as recited in claim 8, the local storage device comprising a storage device that is included as part of the client device.

11. A method as recited in claim 8, further comprising:
receiving, after a second program has aired over the IP-based network, a second request to record the second program locally;
accessing, in response to the second request, over the IP-based network the network buffer; and
downloading, over the IP-based network, the second program from the network buffer to the local storage device.

12. A method as recited in claim 11, wherein the second program is a program identified by a content distributor as being a highly popular program.

13. A method implemented in a content distributor, the method comprising:
obtaining information identifying a popularity of each of multiple programs being aired;
identifying, based on the information, one or more highly popular programs of the multiple programs; and
sending, to each of multiple client devices, a request for the client device to download the one or more highly popular programs after the one or more highly popular programs have aired.

14. A method as recited in claim 13, further comprising:
receiving, from one of the multiple client devices, a request to download a highly popular program;
accessing a network buffer at which all previously aired programs have been temporarily stored; and
downloading the requested highly popular program to the one of the multiple client devices.

15. A method as recited in claim 13, further comprising including in the request an indication of an amount of bandwidth that the client device can use to download the one or more highly popular programs.

16. A method as recited in claim 13, wherein the obtaining comprises generating a popularity for each of the multiple programs.

17. A method as recited in claim 13, the identifying comprising automatically identifying the one or more highly popular programs based at least in part on the information identifying the popularity of each of the multiple programs.

18. A method as recited in claim 13, wherein the popularity of one of the multiple programs is based at least in part on how many users watched the program.

19. A method as recited in claim 13, wherein the popularity of one of the multiple programs is based at least in part on how many users recorded the program.

20. A method as recited in claim 13, wherein the multiple programs have been previously aired.
